(19) United States
(12) Patent Application Publication
(10) Pub. No.: US 2016/0149305 A1
(43) Pub. Date: May 26, 2016

(54) ANTENNA DEVICE AND NEAR FIELD COMMUNICATION DEVICE INCLUDING THE SAME

(71) Applicant: SAMSUNG ELECTRO-MECHANICS CO., LTD., Suwon-Si (KR)

(72) Inventors: Hyung Jin JEON, Suwon-Si (KR); Jung Wook SEO, Suwon-Si (KR)

(21) Appl. No.: 14/859,199

(22) Filed: Sep. 18, 2015

(30) Foreign Application Priority Data
Nov. 26, 2014 (KR) 10-2014-0166916

(51) Int. Cl. H01Q 7/06; H01Q 1/48

(52) U.S. Cl. CPC H01Q 7/06; H01Q 1/48

(57) ABSTRACT

An antenna device may include a substrate, a first coil formed on the substrate, a second coil formed on the substrate and formed outside of the first coil, and a magnetic sheet interposed between the substrate and the first coil. Whereby, the second coil formed around the first coil removes electromotive force formed by a magnetic field passing through the outside of the first coil such that a communication distance and communication strength may be improved.

### CROSS-REFERENCE TO RELATED APPLICATION

This application claims the priority and benefit of Korean Patent Application No. 10-2014-0166916 filed on Nov. 26, 2014, with the Korean Intellectual Property Office, the disclosure of which is incorporated herein by reference.

### BACKGROUND

The present disclosure relates to an antenna device and a near field communication (NFC) device including the same.

Near field communication (NFC) devices are used for the purposes of data exchange and payment approval at communication distances of less than 10 cm, utilizing a frequency within a predetermined region.

Such an NFC device is operated using a principle in which a current is induced thereinto from a receiving coil disposed adjacently thereto when an alternating current (AC) voltage is applied to a transmitting coil of the NFC device to generate lines of magnetic force.

NFC devices have a wide range of applications in a variety of fields, such as in transportation, ticketing, mobile electronic payment approval, inter-device data exchanges, and the like, while one device thereof is operated as a transmitting antenna device and the other device is operated as a receiving antenna device.

Since NFC devices use electromagnetic induction, a transmission/reception rate thereof may be varied, depending on relative positions of transmitting and receiving coils.

In general, a coil of the transmitting antenna device may be fabricated to have a wide area, while a coil of the receiving antenna device may be fabricated to have a small area, for the purpose of miniaturization and thinning of electronic devices.

In this case, a magnetic field generated by the coil of the transmitting antenna device passes through an inner portion and an outer portion of the coil of the receiving antenna device, which may cause a decrease in a communication distance and communication strength.

Therefore, a method allowing for transmission and reception rates of NFC devices to be improved has been demanded.

### SUMMARY

An exemplary embodiment of the present disclosure may provide an antenna device having an improved communication distance and communication strength, and a near field communication (NFC) device including the same.

According to an exemplary embodiment of the present disclosure, an antenna device may include a substrate, a first coil formed on the substrate, a second coil formed on the substrate and formed outside of the first coil, and a magnetic sheet interposed between the substrate and the first coil.

According to an exemplary embodiment of the present disclosure, an antenna device may include a substrate, a first coil formed on the substrate, a second coil formed on the substrate and formed outside of the first coil, and a magnetic sheet interposed between the substrate and the first coil. Here, the magnetic sheet may be embedded in the substrate.

According to an exemplary embodiment of the present disclosure, a near field communication (NFC) device may include a receiving antenna device including a substrate, a first coil formed on the substrate, a second coil formed on the substrate and formed outside of the first coil, and a magnetic sheet interposed between the substrate and the first coil, and a transmitting antenna device including a transmitting coil having a size greater than a size of the first coil.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic exploded perspective view of an antenna device according to an exemplary embodiment of the present disclosure;

FIG. 2 is a schematic perspective view of the antenna device according to an exemplary embodiment of the present disclosure;

FIG. 3 is a schematic plan view of the antenna device according to an exemplary embodiment of the present disclosure;

FIG. 4 is a schematic exploded perspective view of an antenna device according to another exemplary embodiment of the present disclosure;

FIG. 5 is a schematic perspective view of the antenna device according to another exemplary embodiment of the present disclosure;

FIG. 6 is a perspective view of a near field communication (NFC) device according to another exemplary embodiment of the present disclosure;

FIG. 7 schematically illustrates lines of magnetic force flowing from a transmitting antenna to a receiving antenna; and

FIG. 8 schematically is a flow of electromotive force formed by the lines of magnetic force of the receiving antenna of FIG. 7.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements maybe exaggerated for clarity, and the same reference numerals will be used throughout to designate the same or like elements.

Herein, in describing the present exemplary embodiment, a near field communication (NFC) device generally designates an NFC transmitter and an NFC receiver.

In addition, the present disclosure will be described based on near field communications (NFC), but the present disclosure may also be used as a contactless power transmitter, and is not limited thereto.

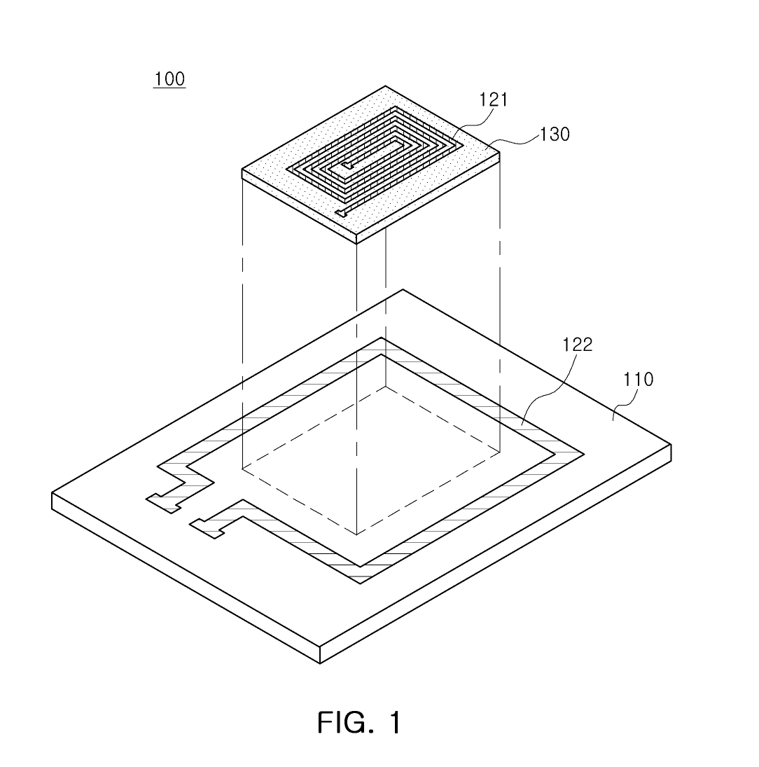

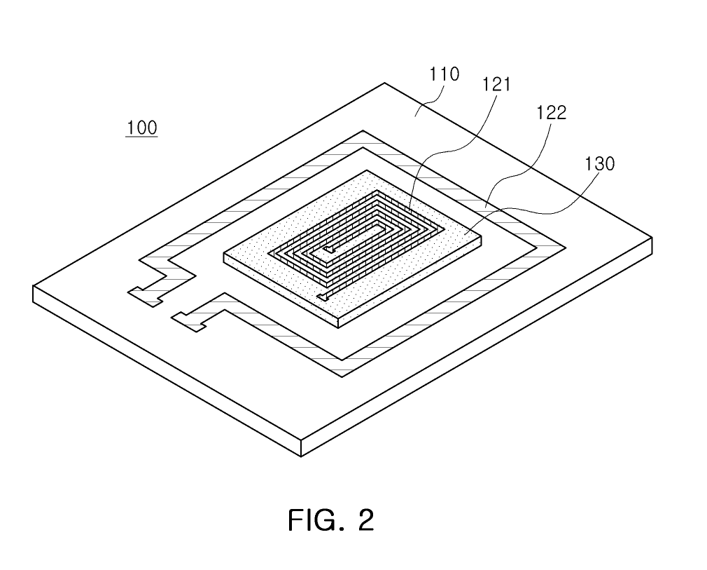

FIG. 1 is a schematic exploded perspective view of an antenna device according to an exemplary embodiment of the present disclosure and FIG. 2 is a schematic perspective view of the antenna device according to an exemplary embodiment of the present disclosure.

Referring to FIGS. 1 and 2, an antenna device 100 according to an exemplary embodiment of the present disclosure may include a substrate 110, first and second coils 121 and 122, and a magnetic sheet 130.

The substrate 110 may be a printed circuit board (PCB), and may be formed of a different type of flat material, if necessary.

The first coil 121 may be formed to be thin, and a thickness of the first coil 121 may be 5 to 95 μm.

The first coil 121 maybe formed of a conductive material such as copper (Cu) or aluminum (Al).

The first coil 121 may have a spiral pattern, and may have a circular or rectangular pattern, if necessary.

Both end portions of the first coil 121 may be electrically connected externally, and an inner edge portion of the first coil 121 may be electrically connected externally using a via electrode, or the like.

The first coil 121 may serve as a main loop antenna for near field communications (NFC).

The second coil 122 may be formed to be thin, and a thickness of the second coil 122 may be 5 to 95 μm.

The second coil 122 may be formed of a conductive material such as copper (Cu) or aluminum (Al).

The second coil 122 may have a circular or rectangular pattern, and may have a spiral pattern, if necessary.

Both end portions of the second coil 122 maybe grounded by connecting to a ground electrode.

The second coil 122 may be formed outside of the first coil 121, and may serve to improve a communication distance and communication strength when the first coil 121 serves as the main loop antenna.

In detail, the first coil 121 may be disposed inwardly of a coil wire of the second coil 122.

The magnetic sheet 130 may be interposed between the first coil 121 and the substrate 110.

The magnetic sheet 130 may be manufactured using a ferrite sheet, an amorphous metal, a sheet using a metallic powder, and the like, but is not limited thereto.

The ferrite sheet may be at least one selected from a group consisting of NiZnCu, MnZn, and (M, Y, W or Z)-type ferrite, but is not limited thereto.

The amorphous metal may be at least one selected from a group consisting of Ni, Fe, and Co base metals, but is not limited thereto.

In the case of the sheet using the metallic powders, a resin may be used to mix the metallic powders to form the magnetic sheet. The resin may be at least one selected from a group consisting of chlorinated polyethylene, polypropylene, ethylene-propylene rubber, natural rubber, acrylonitrile-butadiene, polyvinyl chloride, polyimide-based and polyester-based resins, but is not limited thereto.

When the first coil 121 serves as the main loop antenna, the magnetic sheet 130 may concentrate a flow of the magnetic field to the first coil 121 to improve the communication distance and communication strength.

In detail, the magnetic sheet 130 may only be interposed between the first coil 121 and the substrate 110, and may not be interposed below the second coil 122 and the substrate 110.

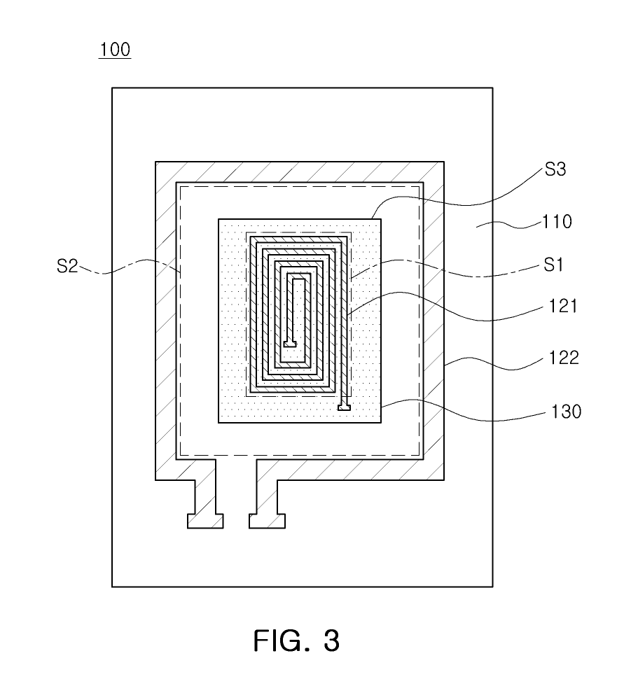

FIG. 3 is a schematic plan view of the antenna device according to an exemplary embodiment of the present disclosure.

Referring to FIG. 3, it may be seen that a width of the first coil 121 is less than a width of the second coil 122.

For example, an area S2 of the second coil 122 may be in a range of being greater than one time and being equal to or less than three times an area S1 of the first coil 121. The area S1 of the first coil 121 refers to a minimum area of which boundaries are defined by the outermost loop of the wire that forms the first coil 121, and the area S2 of the second coil 122 refers to a maximum area substantially surrounded by the innermost loop of the wire that forms the second coil 122, although in FIG. 3, for the purpose of illustration, S1 is not disposed exactly on the edge of the first coil 121 and S2 is not disposed exactly on the edge of the second coil 122.

In a case in which the area S2 of the second coil 122 is equal to or smaller than the area S1 of the first coil 121, both coils may be overlapped, and in a case in which the area S2 of the second coil 122 is more than three times the area S1 of the first coil 121, since it may be difficult for the second coil 122 to serve to prevent electromotive force formed by the lines of magnetic force flowing outside of the first coil 121, the communication distance and communication strength may not improved.

In order to improve the communication distance and communication strength, an area S3 of the magnetic sheet 130 may be formed to be greater than the area S1 of the first coil 121 and smaller than the area S2 of the second coil 122.

In a case in which the area S3 of the magnetic sheet 130 is formed to be smaller than the area S1 of the first coil 121 and greater than the area S2 of the second coil 122, the flow of the magnetic field may not be concentrated.

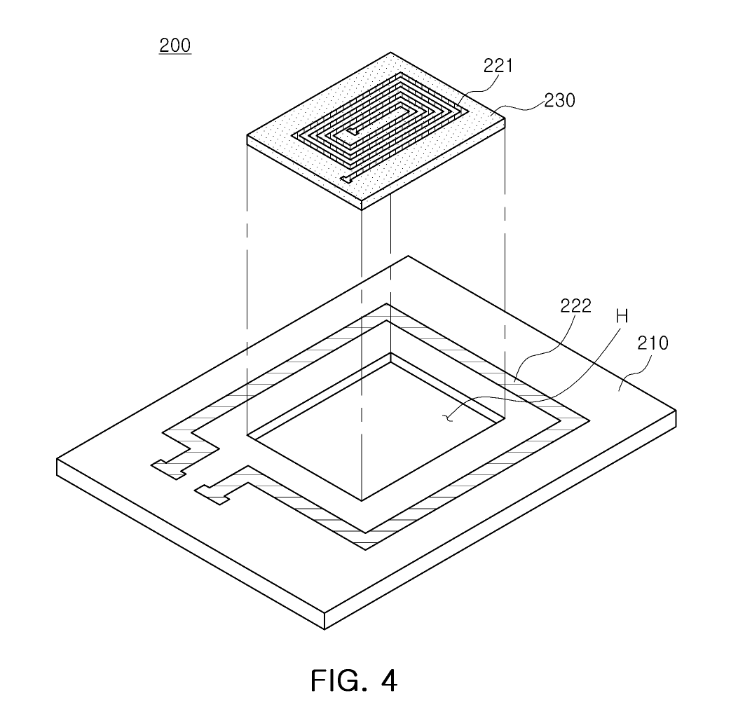

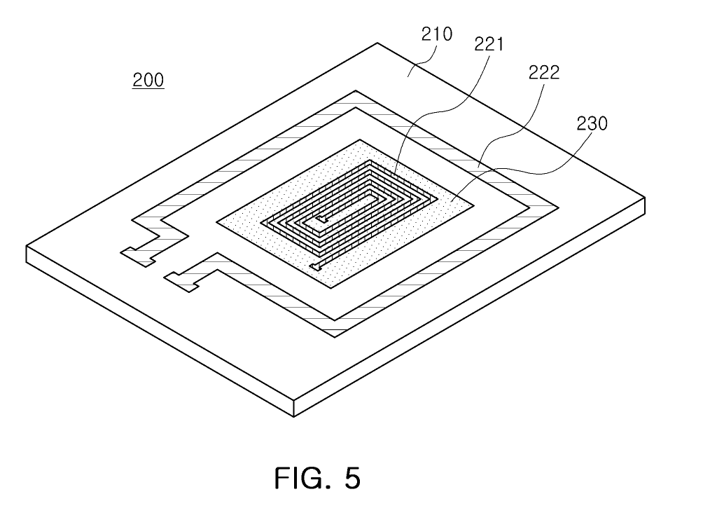

FIG. 4 is a schematic exploded perspective view of an antenna device 200 according to another exemplary embodiment of the present disclosure and FIG. 5 is a schematic perspective view of the antenna device according to another exemplary embodiment of the present disclosure.

A first coil 221 may be formed to be thin, and a thickness of the first coil 221 may be 5 to 95 μm.

The first coil 221 may be formed of a conductive material such as copper (Cu) or aluminum (Al).

The first coil 221 may have a spiral pattern, and may also have a circular or rectangular pattern, if necessary.

Both end portions of the first coil 221 may be electrically connected to the outside, and an inner edge portion of the first coil 221 may be electrically connected to the outside using a via electrode, or the like.

The first coil 221 may serve as a main loop antenna for near field communications (NFC).

A second coil 222 may be formed to be thin, and a thickness of the second coil 222 may be 5 to 95 μm.

The second coil 222 may be formed of a conductive material such as copper (Cu) or aluminum (Al).

The second coil 222 may have a circular or rectangular pattern, and have a spiral pattern, if necessary.

Both end portions of the second coil 222 maybe grounded to a ground electrode.

The second coil 222 may be formed outside of the first coil 221, and may serve to improve a communication distance and communication strength when the first coil 221 serves as the main loop antenna.

In detail, the first coil 222 may be disposed inwardly of a coil wire of the second coil 221.

A magnetic sheet 230 may be interposed between the first coil 221 and a substrate 210.

A material of the magnetic sheet 230 may be a ferrite soft magnetic material, preferably, NiZnCu or MnZn, but is not limited thereto.

When the first coil 221 serves as the main loop antenna, the magnetic sheet 230 may concentrate a flow of the magnetic field to the first coil 221 to improve the communication distance and communication strength.

In detail, the magnetic sheet 230 may only be interposed between the first coil 221 and the substrate 210, and may not be interposed below the second coil 222 and the substrate 210.

Referring to FIG. 4, a recess H may be formed in the substrate 210.

When the magnetic sheet 230 is formed to concentrate the flow of the magnetic field, a total of thickness of the antenna device cannot help being increased by an amount equal to a thickness of the magnetic sheet 230.

Thus, in order to prevent the total thickness of the antenna device from being increased, the recess H may be formed in the substrate 210 and the magnetic sheet 230 may be embedded in the substrate 210 as illustrated in FIG. 5.

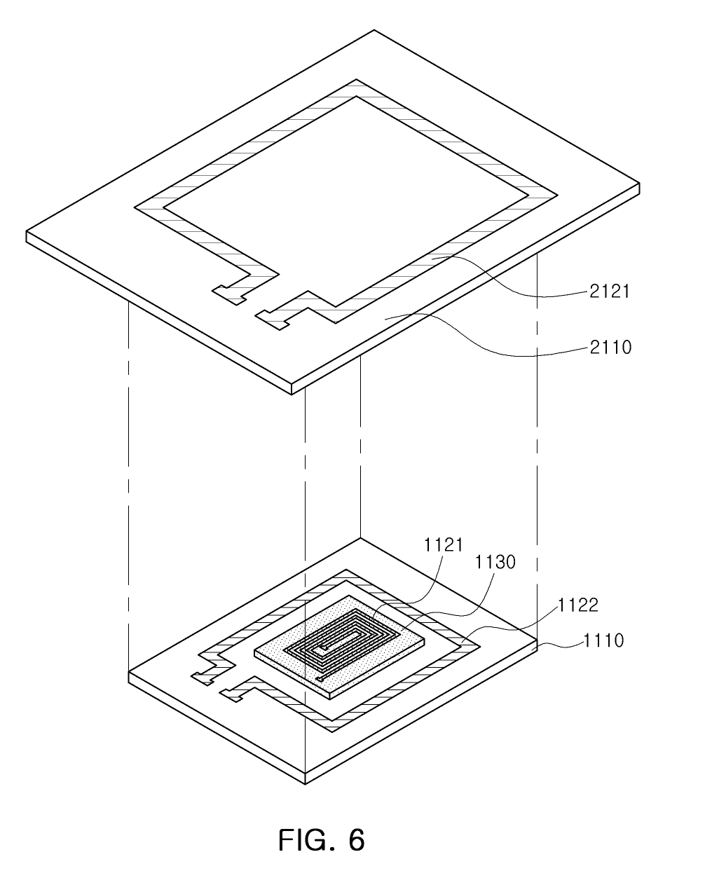

FIG. 6 is a perspective view of a near field communication (NFC) device according to another exemplary embodiment of the present disclosure.

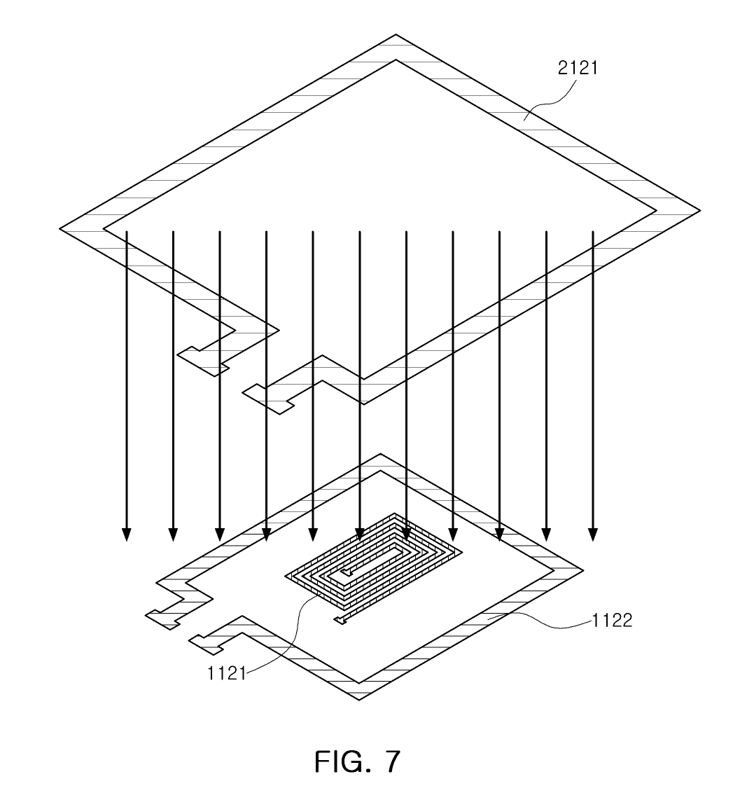

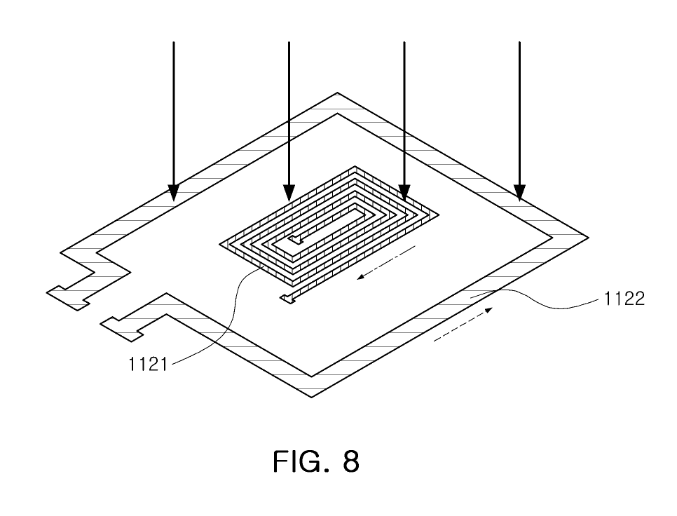

In addition, FIG. 7 schematically illustrates lines of magnetic force flowing from a transmitting antenna to a receiving antenna and FIG. 8 schematically illustrates a flow of electromotive force formed by the lines of magnetic force of the receiving antenna of FIG. 7.

Referring to FIG. 6, the NFC device according to the present disclosure may include a receiving antenna device and a transmitting antenna device.

The transmitting antenna device may include a substrate 2110 and a transmitting coil 2121.

The transmitting coil 2121 may be formed to be thin, and a thickness of the transmitting coil 2121 may be 5 to 95 μm.

The transmitting coil 2121 may be formed of a conductive material such as copper (Cu) or aluminum (Al).

The transmitting coil 2121 may have a spiral pattern, and may have a circular or rectangular pattern, if necessary.

Both end portions of the transmitting coil 2121 may be electrically connected to the outside, and an inner edge portion of the transmitting coil 2121 may be electrically connected to the outside using a via electrode, or the like.

The transmitting coil 2121 may serve as a main loop antenna for near field communications (NFC).

The receiving antenna device may include a substrate 1110, first and second coils 1121 and 1122, and a magnetic sheet 1130.

The receiving antenna device may be attached to a battery pack or a cover of a rear surface of a portable device to perform the near field communications.

In accordance with the miniaturization and thinness of the portable device, the receiving antenna device has also been miniaturized and thinned.

Thereby, a size difference between the transmitting antenna device and the receiving antenna device may occur.

In general, in order to significantly increase communication capability of the transmitting device and the receiving device, an area of a coil of the transmitting antenna device needs to be similar to an area of a coil of the receiving antenna device.

As illustrated in FIG. 7, in a case in which a current flows in the transmitting coil 2121, when the lines of magnetic force (bold arrows) are generated, the lines of magnetic force generated by the transmitting coil 2121 may simultaneously flow into an inner side and an outer side of the first coil 1121 on the basis of the first coil 1121.

In a case in which the second coil 1122 is not present, the lines of magnetic force flowing into the inner side of the first coil 1121 and the lines of magnetic force flowing externally of the first coil 1121 form electromotive force in opposite directions, such that some opposing electromotive force may be canceled out.

Since some of electromotive force is canceled, the communication distance and communication strength may be decreased.

However, in the NFC device according to an exemplary embodiment of the present disclosure, since the second coil 1122 is formed outside of the first coil 1121, the cancellation of the electromotive forces due to the lines of magnetic force flowing outside of the first coil 1121 may be prevented.

In detail, in the case in which the second coil 1122 is connected to the ground electrode, the second coil 1122 serves to remove the electromotive force formed by the magnetic field flowing outside of the first coil 1121, such that the communication distance and communication strength may be increased.

The antenna device and the NFC device including the same according to the present disclosure described above are not limited to the above-mentioned exemplary embodiments but may be variously applied.

In addition, although the antenna device and the NFC device including the same have been described in the above-mentioned exemplary embodiments by way of example, the exemplary embodiments of the present disclosure are not limited thereto, but may be widely used in all electronic apparatuses capable of being wirelessly charged with power and all power transmitters capable of transmitting power wirelessly.

As set forth above, according to exemplary embodiments of the present disclosure, since the second coil formed around the first coil removes electromotive force formed by the magnetic field passing through the outside of the first coil, the antenna device and the NFC device including the same may improve the communication distance and communication strength.

While exemplary embodiments have been shown and described above, it will be apparent to those skilled in the art that modifications and variations could be made without departing from the scope of the present invention as defined by the appended claims.

What is claimed is:

1. An antenna device comprising:
a substrate;
a first coil formed on the substrate;
a second coil formed on the substrate and formed outside of the first coil; and
a magnetic sheet interposed between the substrate and the first coil.

2. The antenna device of claim 1, wherein the second coil is grounded by connecting a ground electrode.

3. The antenna device of claim 1, wherein:
an area of the second coil is in a range of being greater than an area of the first coil and being equal to or less than three times the area of the first coil, and
the area of the first coil is a minimum area of which boundaries are defined by an outermost loop of a wire that forms the first coil, and the area of the second coil is a maximum area substantially surrounded by an innermost loop of a wire that forms the second coil.

4. The antenna device of claim 1, wherein the substrate has a recess in a region surrounded by the second coil.

5. The antenna device of claim 4, wherein the magnetic sheet is disposed in the recess and embedded in the substrate.

6. The antenna device of claim 1, wherein:
an area of the magnetic sheet is greater than an area of the first coil and smaller than an area of the second coil, and
the area of the first coil is a minimum area of which boundaries are defined by an outermost loop of a wire that forms the first coil, and the area of the second coil is a maximum area substantially surrounded by an innermost loop of a wire that forms the second coil.

7. A near field communication (NFC) device comprising:
a receiving antenna device including a substrate, a first coil formed on the substrate, a second coil formed on the substrate and formed outside of the first coil, and a magnetic sheet interposed between the substrate and the first coil; and
a transmitting antenna device including a transmitting coil having a size greater than a size of the first coil.

8. The NFC device of claim 7, wherein the second coil is grounded by connecting to a ground electrode.

9. The NFC device of claim 8, wherein the second coil serves to remove electromotive force formed by a magnetic field flowing from the transmitting coil externally of the first coil.

10. The NFC device of claim 7, wherein:
an area of the second coil is in a range of being greater than an area of the first coil and being equal to or less than three times the area of the first coil, and
the area of the first coil is a minimum area of which boundaries are defined by an outermost loop of a wire that forms the first coil, and the area of the second coil is a maximum area substantially surrounded by an innermost loop of a wire that forms the second coil.

11. The NFC device of claim 7, wherein the substrate has a recess in a region surrounded by the second coil.

12. The NFC device of claim 11, wherein the magnetic sheet is embedded in the substrate.

13. The NFC device of claim 7, wherein:
an area of the magnetic sheet is greater than an area of the first coil and smaller than an area of the second coil, and
the area of the first coil is a minimum area of which boundaries are defined by an outermost loop of a wire that forms the first coil, and the area of the second coil is a maximum area substantially surrounded by an innermost loop of a wire that forms the second coil.
